(19) United States
(12) Patent Application Publication
(10) Pub. No.: US 2010/0117809 A1
(43) Pub. Date: May 13, 2010

(54) DISPLAY MODULE WITH PIEZOELECTRIC HAPTICS

(75) Inventors: Xunhu Dai, Gilbert, AZ (US); Paul Baciu, Mundelein, IL (US); Zhiming Zhuang, Kildeer, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: MOTOROLA INC., Tempe, AZ (US)

(21) Appl. No.: 12/268,628

(22) Filed: Nov. 11, 2008

(51) Int. Cl. G08B 6/00; G06F 3/041

(52) U.S. Cl. 340/407.2; 345/173

(57) ABSTRACT

A mobile communication terminal (10) is provided. The mobile communication terminal (10) includes a touch sensitive liquid crystal display (LCD) module (12) having a predetermined plurality of touch sensitive areas (20, 22) and a plurality of piezoelectric elements (106, 108, 110, 112) disposed along a periphery of a cover glass of the display module (12) wherein activation of the piezoelectric elements provides tactile feedback to a user of activation of a portion of the touch sensitive LCD module (12) by the user.

### FIELD OF THE INVENTION

The field of the invention relates to displays and more particularly, to touch panel displays.

### BACKGROUND OF THE INVENTION

Touch panel displays are known. Touch panel displays are often used where space is limited, such as in cell phones.

Touch panel displays may include a number of touch pads. The touch pads typically have discrete key locations identified by respective alpha-numeric symbols that are displayed on touch screens such as analog, resistive, infrared, acoustic, capacitive or electromagnetic inductively operated screens.

One difficulty with touch pads is that they do not always provide the user with satisfactory feedback when a touch pad is activated. For example, activation of a key on a conventional keyboard produces detectable motion as the key is activated. On regular phone keypads, a popple dome may be placed underneath each key. Each dome deflects downward to provide a perceptible tactile “click” when a key is activated.

In the case of a touch pad, the completion of a keystroke can often be seen on the user's screen, but cannot be felt. In the case of capacitive or resistive touch pads, the user simply places his/her finger on the touch pad. In either case, a controller detects a change in capacitance or resistance as an indication of activation of the touch pad.

While touch panels work relatively well, they are often subject to errors. For example, if the processor monitoring the touch pads is busy with other matters (e.g., placing a call in the case of a cell phone) and doesn't immediately display the character associated with an activated touch pad, then the user may immediately activate the touch pad a second time leading to unexpected results. Similarly, if a user is unsure that he/she has activated a touch pad, then the user may activate the touch pad a second time, again leading to unexpected results. Because of the importance of touch panels, a need exists for better method of confirming activation of touch pads on touch panels.

### SUMMARY

A mobile communication terminal is provided. The mobile communication terminal includes a touch sensitive liquid crystal display (LCD) module having a predetermined plurality of touch sensitive areas and a plurality of piezoelectric elements disposed along a periphery of a cover glass of the display module wherein activation of the piezoelectric elements provides tactile feedback to a user of activation of a portion of the touch sensitive LCD module by the user.

In another embodiment the mobile communication terminal includes the context wherein the touch sensitive LCD module further comprises an LCD cover glasses that house the liquid crystal.

In another embodiment the mobile communication terminal includes the context wherein the LCD further comprises a front display cover glass surface and a rear display cover glass surface with the plurality of piezoelectric elements disposed on the rear surface along a set of outside edges of the LCD active area.

In another embodiment the mobile communication terminal includes a plurality of thin film wires disposed on the rear surface connecting the plurality of piezoelectric elements to a driver.

In another embodiment the mobile communication terminal includes a plurality of flex circuit boards connecting the plurality of piezoelectric elements to a driver.

In another embodiment the mobile communication terminal includes a controller that detects activation of a portion of the touch sensitive display and in response activates at least some of the plurality of piezoelectric elements.

In another embodiment the mobile communication terminal includes a drive signal applied to the at least some of the piezoelectric elements.

In another embodiment the mobile communication terminal includes the context wherein the drive signal further comprises a temporal length of 0.001 to 0.5 seconds first following activation of the portion of the touch sensitive display.

In another embodiment, the mobile communication terminal includes an LCD, a touch sensitive panel having a plurality of discrete, non-overlapping touch sensitive areas, said touch sensitive panel disposed over a viewing surface of the LCD and a plurality of piezoelectric elements disposed along a periphery of a rear surface of the LCD glass.

In another embodiment, the mobile communication terminal is a cellular telephone.

In another embodiment, the mobile communication terminal includes the context wherein the cellular telephone further comprises a housing and flexible mount wherein the flexible mount isolates the housing from vibration from the LCD display.

In another embodiment, the mobile communication terminal includes an LCD having an upper viewing cover glass and a lower cover glass, a touch sensitive member disposed on the upper viewing glass cover of the LCD and a plurality of piezoelectric elements disposed around a periphery of the lower cover glass and outside of a viewing area of the LCD.

### BRIEF DESCRIPTION OF THE DRAWINGS

FIG. 1 is a block diagram of a mobile communication terminal in accordance with an illustrated embodiment of the invention;

FIG. 2 is a cut-away side view of an LCD display module that may be used with the mobile communication terminal of FIG. 1;

FIG. 3 is a bottom view of an LCD display that may be used within the LCD display module of FIG. 2;

FIG. 4 shows a lower LCD glass of the LCD display of FIG. 3 with a set of thin film wires on a rear surface;

FIG. 5 shows the lower LCD glass of FIG. 4 with a dielectric layer disposed over the thin film wires;

FIG. 6 shows the lower LCD glass of FIG. 5 with piezoelectric elements disposed over the dielectric layer and with a flex connector connected to the thin film wires; and

FIG. 7 shows a cut-away side view of the LCD display module of FIG. 1 after the steps of FIGS. 4-7.

### DETAILED DESCRIPTION OF AN ILLUSTRATED EMBODIMENT

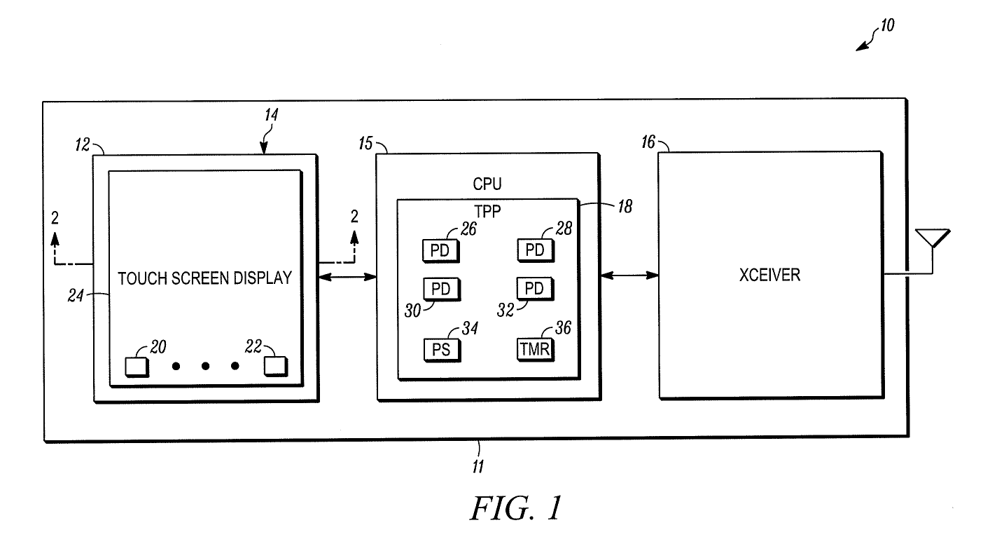

FIG. 1 is a block diagram of a mobile communication terminal (e.g., a cellular telephone) 10 with a touch sensitive liquid crystal display (LCD) module 12 shown generally in accordance with an illustrated embodiment of the invention. In the case where the device 10 is a cellular telephone, the device 10 may include a controller 15 and a transceiver 16.

The touch sensitive LCD module 12 may include LCD glasses 14 with a predetermined set of discrete, non-overlapping touch sensitive areas 20, 22. The touch sensitive areas 20, 22 may use any appropriate touch detection mechanism (e.g., capacitance, resistance, optical, acoustic, etc.) incorporated into a transparent member (e.g., a panel, flexible member, etc.) 24 disposed over a viewing surface of the LCD glasses 14.

In order to place a call, a user (not shown) may activate the mobile communication terminal 10 and enter a dialed number through one or more of the touch sensitive areas 20, 22 located on the LCD galsses 14 of the touch panel module 12. A touch panel processor 18 within the controller 15 may monitor the touch sensitive areas 20, 22 to detect the string of numbers. The touch panel processor 18 may identify the specific touch pads 20, 22 by monitoring each row and column of the touch panel 24.

Once the touch panel processor 18 has identified the activated touch sensitive area 20, 22, the touch panel processor 18 may identify the digit or action intended and proceed accordingly. For example, if the activated touch sensitive area 20, 22 is a digit, then the touch panel processor 18 may accumulate the digit in anticipation of placing a call. If the touch sensitive area 20, 22 is MAKE CALL button 20, 22, then the touch panel processor 18 may transfer a collected sequence of digits to the transceiver 16.

In response, the transceiver 16 may search for a local base station and request a radio frequency channel. Once a channel has been granted, the transceiver 16 may transfer the sequence of digits to the base station, the base station may set up a call connection with the called party and the call may proceed in a conventional manner.

Under illustrated embodiments of the invention, the touch sensitive LCD module 12 provides tactile feedback in response to activation of each touch sensitive area 20, 22. Tactile feedback in this case means a tactile sensation delivered to the finger activating a touch sensitive area 20, 22 without delivering that same tactile sensation to the outside surface 11 of the mobile communication terminal 10.

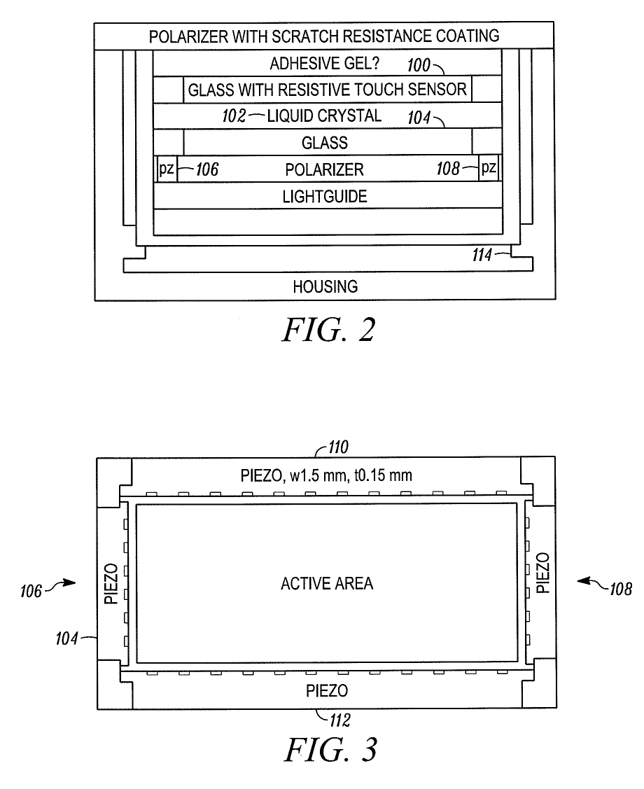

FIG. 2 is a cut-away side view of the LCD galsses 14 within the touch sensitive LCD module 12. As shown in FIG. 2, the LCD glasses 14 contain a pair of cover glass plates 100, 104 including an upper cover glass 100 on a viewing side, a lower cover glass 104 on the bottom and the liquid crystal 102 located between the glass plates 102, 104. Also shown in FIG. 2 is a set of piezoelectric elements 106, 108 attached to a bottom surface of the lower glass plate 104 and extending along a periphery of the lower glass plate 104.

FIG. 3 is a bottom view of the lower glass plate 104. As shown in FIG. 3, the lower glass plate 104 includes four piezoelectric elements 106, 108, 110,112 extending along the periphery of the plate 104 and only along the periphery. The piezoelectric elements 106, 108, 110 and 112 are placed outside the active area of the LCD.

The signal to the four piezoelectric elements is applied to top and bottom surfaces (i.e., the top surface is adjacent the glass and the bottom faces away from the glass). The piezoelectric elements may have wrapped-around electrodes that extends an electrode on one surface to the other surface through side electrode connection. With wrapped-around electrode a piezoelectric element could thus be accessed electrically from one surface. When the piezoelectric elements are activated on the top and bottom surfaces, the piezoelectric elements bend the predominant surfaces of the LCD display 14. This rapid bending causes acceleration (i.e., vibration) that is perpendicular to the predominant surfaces of the LCD glasses 14.

In use, the piezoelectric elements 106, 108, 110, 112 may be activated in conjunction with detection of activation of any of the touch sensitive areas 20, 22. Included within the controller 15 may be one or more drivers 26, 28, 30, 32 for imposing an electric signal onto the piezoelectric elements 106, 108, 110, 112. Under one embodiment one driver 26, 28, 30, 32 is provided for each respective piezoelectric element 106, 108, 110, 112. Under another embodiment, one driver 26, 28, 30, 32 may be provided that drives all of the piezoelectric elements 106, 108, 110, 112 in parallel.

Also included within the controller 15 may be a signal source 34 that provides a drive signal to the piezoelectric elements 106, 108, 110, 112 through the drivers 26, 28, 30, 32. Under one illustrated embodiment, the drive signal provided by the signal source 34 may be a single wave or a pulse train.

In use, the touch panel processor 18 monitors the touch sensitive areas 20, 22 for activation. Upon activation of a touch sensitive area 20, 22, the touch panel processor 18 activates the piezoelectric elements 106, 108, 110, 112 for a predetermined time period (e.g., 0.001-0.5 seconds). Under one illustrated embodiment, the touch panel processor 18 sets a timer 36 with the predetermined time period and at the same time activates the drivers 26, 28, 30, 32 thereby applying the drive signal to the piezoelectric elements 106, 108, 110, 112. At the end of the predetermined time period, the touch panel processor 18 deactivates the piezoelectric elements 106, 108, 110, 112.

By activating the piezoelectric elements 106, 108, 110, 112 for the predetermined time period first following detection of activation of a touch sensitive area 20, 22, the user is given tactile feedback. The tactile feedback is this case is somewhat similar to the distinctive “click” felt when a user activates a key with popple dome in a regular keypad.

Moreover, since the piezoelectric elements 106, 108, 110, 112 are attached to the bottom glass 104 around the periphery, the location of the piezoelectric elements does not interfere with operation of the LCD

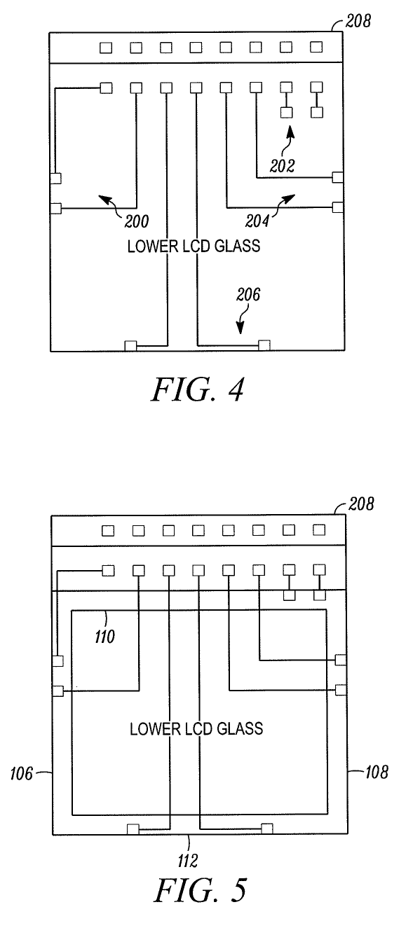

FIGS. 4-7 show details of the construction of the LCD glasses 14. As shown in FIG. 4, a set of transparent thin film wires may be formed on a bottom surface of the lower glass 104. For example the film material could be indium tin oxide (ITO)As shown, a first set of contacts 200 are provided for contact with a first piezoelectric element 106, a second set of contacts 202 are provided for contact with a first piezoelectric element 110, a third set of contacts 204 are provided for contact with a first piezoelectric element 108 and a fourth set of contacts 206 are provided for contact with a first piezoelectric element 112.

Once the thin film wires are disposed on the lower glass 104, a decorative dielectric layer may be disposed on the lower surface as shown in FIG. 5. In this case, the contacts 200, 202, 204 and 206 are left exposed.

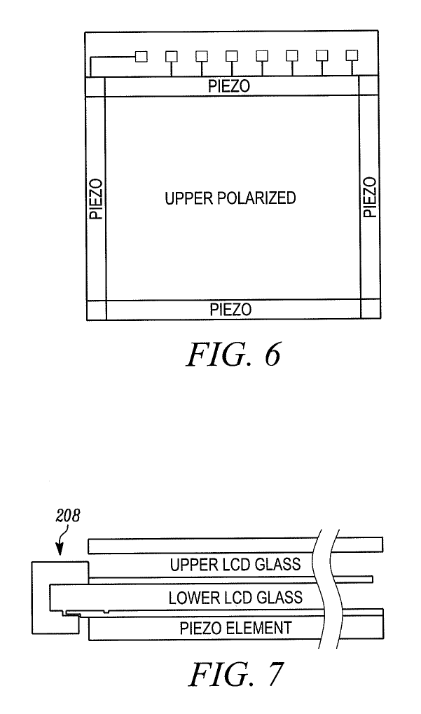

In a subsequent step (shown in FIG. 6) the piezoelectric elements 106, 108, 110, 112 are bonded to the dielectric layer using an appropriate adhesive (e.g., an anisotropic paste). As part of the bonding process, the contacts 200, 202, 204, 206 are bonded to the same surface of the piezoelectric elements 106, 108, 110, 112 that have wrapped-around electrode. A flex connector 208 is also folded across the end of the lower glass 104 to form a connection between the connectors 200, 202, 204, 206 and controller 15.

In another illustrated embodiment, the controller 15 may only activate a portion of the piezoelectric elements 106, 108, 110, 112. In this case, the controller 15 may detect activation of a touch sensitive area 20, 22 and only activate the one or two piezoelectric elements 106, 108, 110, 112 that are closest to the activated touch sensitive area 20, 22.

The claimed touch sensitive LCD module 12 is a significant improvement over prior art devices on a number of different levels. For example, the LCD glasses 14 could be mounted using flexible materials inside the bezel of the touch sensitive LCD module 12. In this case, the flexible mount effectively isolates the housing from vibration of the LCD glasses 14 caused by the piezoelectric elements 106, 108, 110, 112. As such, activation of the piezoelectric elements 106, 108, 110, 112 is only felt on the LCD galsses 14 and not on the bezel of display module and overall phone housing 11.

Prior art methods of providing haptics for activation of touch sensitive areas have relied upon a call alerting motor that shakes the entire device 10. Since the LCD display 14 floats within the bezel of the touch sensitive LCD module 12, the vibrational haptics from the piezoelectric elements 106, 108, 110, 112 are not felt through the housing of the device 10, but only by the finger of the user that is in contact with a touch sensitive area 20, 22.

Human factor studies have suggested that localized haptics (i.e., tactile feedback where a user touches the touch sensitive LCD module 12) is a much more compelling experience. Not only is the experience more compelling, but the availability of immediate feedback reduces errors because the user is immediately alerted that a selection has been accepted by the device 10.

A specific embodiment of method and apparatus for providing keyboard haptics has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A mobile communication terminal comprising:
a touch sensitive liquid crystal display (LCD) module having a predetermined plurality of touch sensitive areas; and
a plurality of piezoelectric elements disposed along a periphery of a cover glass of the display module wherein activation of the piezoelectric elements provides tactile feedback to a user confirming activation of a portion of the touch sensitive LCD module by the user.

2. The mobile communication terminal as in claim 1 wherein the touch sensitive LCD module further comprises an LCD glasses.

3. The mobile communication terminal as in claim 2 wherein the LCD glasses further comprises a front display cover glass surface and a rear cover glass surface with the plurality of piezoelectric elements disposed on the rear surface along a set of outside edges of the LCD active area.

4. The mobile communication terminal as in claim 3 further comprising a plurality of transparent thin film wires disposed on the rear surface connecting the plurality of piezoelectric elements to a driver.

5. The mobile communication terminal as in claim 3 comprising a plurality of flex circuit boards connecting the plurality of piezoelectric elements to a driver.

6. The mobile communication terminal as in claim 1 further comprising a controller that detects activation of a portion of the touch sensitive display and in response activates at least some of the plurality of piezoelectric elements.

7. The mobile communication terminal as in claim 5 further comprising a drive signal applied to the at least some of the piezoelectric elements.

8. The mobile communication terminal as in claim 6 wherein the drive signal further comprises a temporal length of 0.001 to 0.5 seconds first following activation of the portion of the touch sensitive display.

9. A mobile communication terminal comprising:
a liquid crystal display (LCD);
a touch sensitive panel having a plurality of discrete, non-overlapping touch sensitive areas, said touch sensitive panel disposed over a viewing surface of the LCD; and
a plurality of piezoelectric elements disposed along a periphery of a rear surface of the LCD.

10. The mobile communication terminal as in claim 8 further comprising a touch panel processor that detects activation of a touch sensitive area of the plurality of touch sensitive areas.

11. The mobile communication terminal as in claim 9 further comprising a driver coupled to the touch panel processor that activates at least some of the plurality of piezoelectric elements in response to detection of activation of the touch sensitive area.

12. The mobile communication terminal as in claim 10 further comprising a signal applied to the at least some piezoelectric elements upon detection of the touch sensitive areas.

13. The mobile communication terminal as in claim 11 wherein the 300 Hz signal further comprises a duration of from 0.001 to 5 seconds first following detection of activation of the touch sensitive area.

14. The mobile communication terminal as in claim 12 further comprising a plurality of thin film wires disposed on the rear surface connecting the plurality of piezoelectric elements to a driver of the signal.

15. The mobile communication terminal as in claim 8 further comprising a cellular telephone.

16. The mobile communication terminal as in claim 14 wherein the cellular telephone further comprises a housing and flexible mount wherein the flexible mount isolates the housing from vibration from the LCD display.

17. A mobile communication terminal comprising:
a liquid crystal display (LCD) having an upper viewing cover glass and a lower cover glass;
a touch sensitive member disposed on the upper viewing glass cover of the LCD; and
a plurality of piezoelectric elements disposed around a periphery of the lower cover glass and outside of a viewing area of the LCD.

18. The mobile communication terminal as in claim 16 further comprising a housing with a flexible mount where the LCD floats within the housing on the flexible mount.

19. The mobile communication terminal as in claim 16 wherein the touch sensitive area further comprises a plurality of touch sensitive areas.

20. The mobile communication terminal as in claim 18 further comprising a touch panel processor that detects activation of a touch sensitive area of the plurality of touch sensitive areas.

21. The mobile communication terminal as in claim 9 further comprising a driver coupled to the touch panel processor that activates at least some of the plurality of piezoelectric elements with a varying voltage signal in response to detection of activation of the touch sensitive area by the touch panel processor.
